(19) United States
(12) Patent Application Publication
(10) Pub. No.: US 2013/0024323 A1
(43) Pub. Date: Jan. 24, 2013

(54) SYSTEM FOR COMPLETING AN ONLINE TRANSACTION

(71) Applicant: Thomas HJ Tomassen, Minnetonka, MN (US)

(72) Inventor: Thomas HJ Tomassen, Minnetonka, MN (US)

(21) Appl. No.: 13/552,716

(22) Filed: Jul. 19, 2012

Related U.S. Application Data
(60) Provisional application No. 61/510,039, filed on Jul. 20, 2011.

(51) Int. Cl. G06Q 30/06

(52) U.S. Cl. 705/26.35

(57) ABSTRACT

A set of computer-executable instructions. The set of computer-executable instructions is configured to connect a user over a network to an exchange and a service provider through the exchange. The set of computer-executable instructions is also configured to allow the user to negotiate a transaction by means of the exchange with the service provider. The set of computer-executable instructions is further configured to allow the exchange and user to enter into a sales contract. The set of computer-executable instructions is additionally configured to receive a payment from the user for deposit hold until completion of the transaction. The set of computer-executable instructions is moreover configured to release the user deposit payment to the exchange.

### CROSS-REFERENCE TO RELATED APPLICATIONS

This application claims the benefit of and priority to U.S. Provisional Patent Application Ser. No. 61/510,039 filed on Jul. 20, 2012, which application is incorporated herein by reference in its entirety.

### BACKGROUND OF THE INVENTION

Online transactions are potentially risky for both parties. For example, a buyer may pay for a service, product or property only to have the delivery fail. I.e., the “seller” can receive the payment and then either refuse to complete the transaction or never have had a service, product or property to sell. This leaves the user without the payment funds and without the service, product or property. Alternatively, the seller may complete only a portion of the transaction and then refuse to complete the remainder after the payment is received.

In addition, the fraud can exist with a seller who is not in a position to deliver the service, product or property. For example, the seller may have the requisite qualifications and/or machinery to provide a service but may be located too remotely geographically to perform the service. Such an occurrence can be a simple misunderstanding or can result from fraud by one of the parties.

In addition, the seller can send the product only to have payment fall through. For example, the buyer can use fraudulent payment information or simply refuse to make the payment at the completion of the transaction. This leaves the seller without the funds and without the ability to sell the service, product or property.)

There are websites that attempt to prevent some fraud. The most common method of preventing fraud is to allow ratings of buyers and/or sellers. That is, if a seller does not deliver the promised services, products or goods the buyer or buyers can rate the seller poorly, alerting other buyers to beware of the seller. However, this only becomes helpful when several buyers have been defrauded. In addition, the seller can reregister under a different name and continue the fraudulent behavior.

Accordingly there is a need in the art for a system that can help prevent fraud in online transactions. In addition, there is a need in the art for a system that can allow users to identify sellers in a local geographic area. Further, there is a need in the art for a system that can allow buyers to be protected. Moreover, there is a need in the art for a system that can allow sellers to be protected.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a system embodied on a computer-readable storage medium bearing computer-executable instructions that, when executed by a processor operatively coupled to memory on a computer that includes a client application for allowing a user and service provider to complete an online transaction. The system includes a processor. The system also includes one or more computer readable media, wherein the one or more computer readable media contain a set of computer-executable instructions. The set of computer-executable instructions is configured to connect a user over a network to an exchange and a service provider through the exchange. The set of computer-executable instructions is also configured to allow the user to negotiate a transaction by means of the exchange with the service provider. The set of computer-executable instructions is further configured to allow the exchange and user to enter into a sales contract. The set of computer-executable instructions is additionally configured to receive a payment from the user for deposit hold until completion of the transaction. The set of computer-executable instructions is moreover configured to release the user deposit payment to the exchange.

Another example embodiment includes a system embodied on a computer-readable storage medium bearing computer-executable instructions that, when executed by a processor operatively coupled to memory on a computer that includes a client application for allowing a user and service provider to complete an online transaction. The system includes a processor. The system also includes one or more computer readable media, wherein the one or more computer readable media contain a set of computer-executable instructions. The set of computer-executable instructions is configured to connect a user over a network to an exchange and a service provider through the exchange. The set of computer-executable instructions is also configured to allow the user to negotiate a transaction by means of the exchange with the service provider, wherein the transaction includes at least one of a service, a product or property to be procured and paid for by the exchange for own account and in advance. The set of computer-executable instructions is further configured to allow the exchange and the user to enter into a sales contract and receive a payment from the user. The set of computer-executable instructions is additionally configured to hold the payment from the user on deposit until the transaction is complete and release the payment to the exchange on transaction completion.

Another example embodiment includes a system embodied on a computer-readable storage medium bearing computer-executable instructions that, when executed by a processor operatively coupled to memory on a computer that includes a client application for allowing a user and service provider to complete an online transaction. The system includes a processor. The system also includes one or more computer readable media, wherein the one or more computer readable media contain a set of computer-executable instructions. The set of computer-executable instructions is configured to connect a user over a network to an exchange and a service provider through the exchange. The set of computer-executable instructions is also configured to allow the user to negotiate a transaction by means of the exchange with the service provider, wherein the transaction includes at least one of a service, a product or property to be procured and paid for by the exchange for own account and in advance. The set of computer-executable instructions is further configured to allow the exchange and the user to enter into a sales contract and receive a payment from the user. The set of computer-executable instructions is additionally configured to hold the payment from the user on deposit until the transaction is complete and determine if the transaction is complete. The set of computer-executable instructions is moreover configured to release the payment to the exchange on transaction completion.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates a system for creating an online exchange;

FIG. 2 illustrates an example of a user interface for use with a system for creating an online exchange;

FIG. 3 is a flowchart illustrating a method of completing a transaction;

FIG. 4 is a flowchart illustrating a method of releasing a deposit payment; and

FIG. 5 illustrates an example of a suitable computing environment in which the invention may be implemented.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

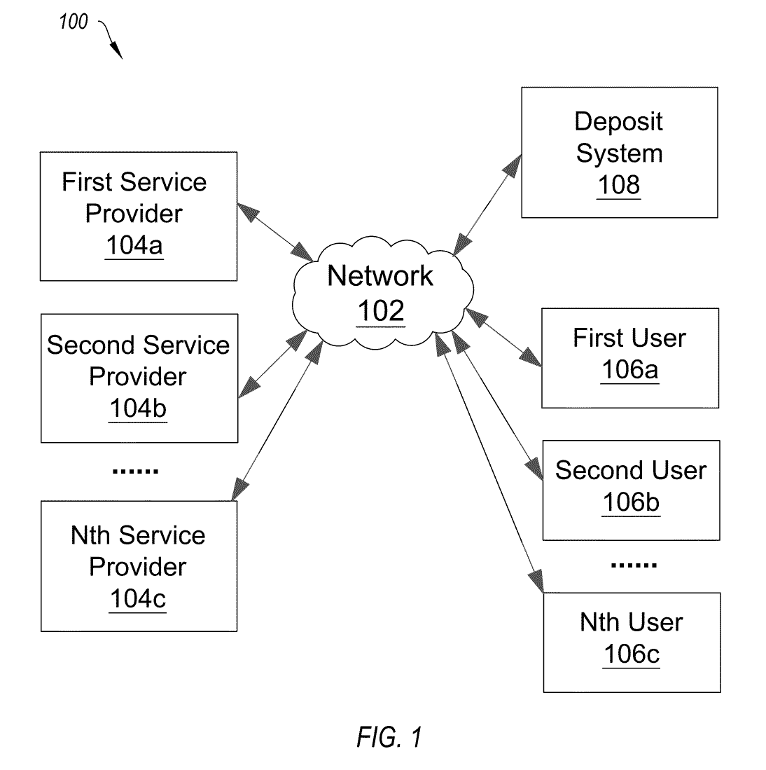

FIG. 1 illustrates a system 100 for creating an online exchange. In at least one implementation, the system 100 can include a location-based online exchange for individuals and businesses. In particular, the system 100 can allow individuals to offer or promote personal or professional skills profiles. Additionally or alternatively, the system 100 can allow individuals to offer or promote personal and commercial products for rent, sale or auction. The system 100 may be accessible to anyone to browse, offer, promote, sell, buy, and pay for products and services, either with or without logging into the system 100.

FIG. 1 shows that the system 100 can include a network 102. In at least one implementation, the network 102 can be used to connect the various parts of the system 100 to one another. The network 102 exemplarily includes the Internet, including a global internetwork formed by logical and physical connections between multiple wide area networks and/or local area networks and can optionally include the World Wide Web (“Web”), including a system of interlinked hypertext documents accessed via the Internet. Alternately or additionally, the network 102 includes one or more cellular RF networks and/or one or more wired and/or wireless networks such as, but not limited to, 802.xx networks, Bluetooth access points, wireless access points, IP-based networks, or the like. For example, the network 102 can include cloud based networking and computing. The network 102 can also include servers that enable one type of network to interface with another type of network.

FIG. 1 also shows that the system 100 can include one or more service providers 104a, 104b and 104c (collectively “service providers 104”). Although a first service provider 104a, a second service provider 104b and an Nth service provider 104c are shown in FIG. 1, the number of service providers that can connect to the network 102 can include a single service provider 104a or any number of service providers 104. That is, the number of service providers 104 that can be connected is without limit. In at least one implementation, the service providers 104 can be any organization that desires to sell a service, product or property. For example, the service providers 104 can include individuals or business entities.

FIG. 1 further shows that the system 100 can include one or more users 106a, 106b and 106c (collectively “users 106”) connected to the network. In particular, the network 102 can allow the users 106 to connect to one or more of the service providers 104 and to other users 106. In at least one implementation, users 106 can include any individual who desires to connect to service providers 104 or other users 106 over the network. For example, the users 106 can include an individual who wishes to purchase a service, product or property. One skilled in the art will appreciate, however, that a user 106 can connect to the network 102 for connection to any service provider 104 or user 106 without restriction and that users 106 can connect to several service providers 104 simultaneously or at various times. Therefore, the product sought by the user 106 should not be seen as limiting the invention, as described herein, unless otherwise specified in the claims. One of skill in the art will further appreciate that a single entity can be both a service provider 104 and a user 106.

FIG. 1 additionally shows that the system 100 can include a deposit system 108. In at least one implementation, the deposit system 108 can include a system to establish and hold a deposit account. For example, the deposit system 108 can establish an account for the purpose of holding funds until the consummation or termination of a transaction with a user. In particular, the deposit system 108 can receive funds from a user 106 for the product or property sold by the exchange to a user 106 until the transaction is complete. The deposit system 108 can then release the funds to the exchange for payment settlement.

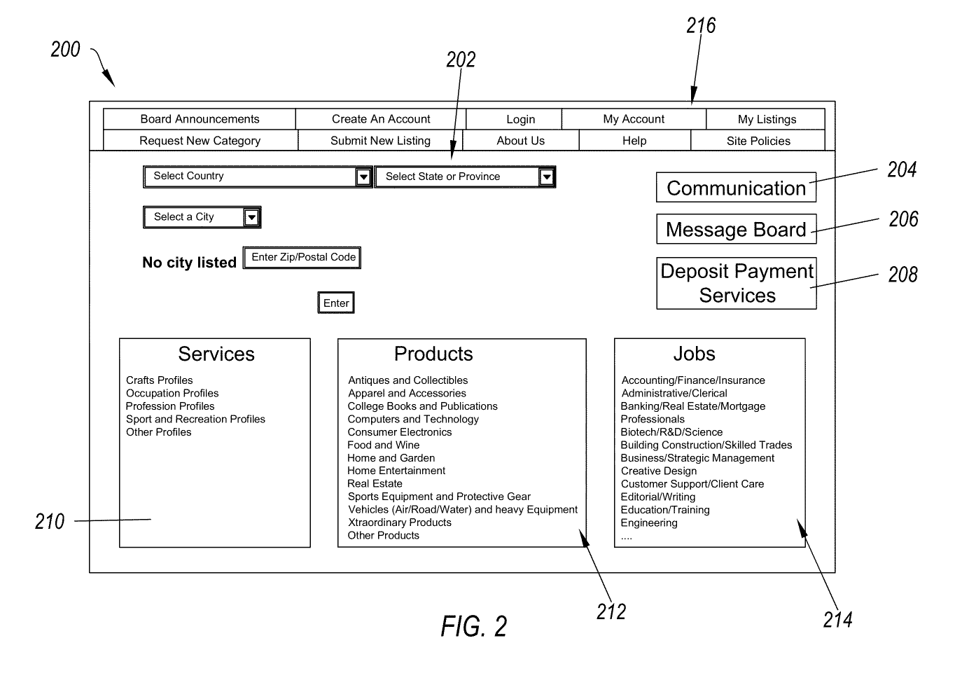

FIG. 2 illustrates an example of a user interface 200 for use with a system for creating an online exchange. In at least one implementation, the user interface 200 can allow the user to view, hear or otherwise interact with the system. In particular, the user interface 200 can allow a user or service provider to directly input or receive data into the system for creating an online exchange. One of skill in the art will appreciate that different user interfaces may be provided to allow users to interact with the system for creating an online exchange in a preferred manner. For example, the user can use a browser, app, program, voice commands, text messaging, email or any other interface. The user interface 200 can include a graphical user interface, controls, speakers, displays or any other necessary hardware and/or software to adequately display desired information to the user, as described below.

In at least one implementation, a graphical user interface (“GUI” sometimes pronounced gooey) is a type of user interface 200 that allows users to interact with electronic devices with images rather than text commands. GUIs can be used in computers, hand-held devices such as MP3 players, portable media file players or gaming devices, cell phones, tablets, household appliances, office equipment and any other desired device. A GUI represents the information and actions available to a user through graphical icons and visual indicators such as secondary notation, as opposed to text-based interfaces, typed command labels or text navigation. The actions are usually performed through direct manipulation of the graphical elements.

FIG. 2 shows that the user interface 200 can include a location selection 202. In at least one implementation, the location selection 202 can allow a user to select a service provider that is local relative to the user. I.e., the user can select a service provider which is capable of interacting with the user in person, if required. In particular, the location selection 202 will allow a user to exclude listings of service providers which are not proximate to the user. To validate the correctness of user address information entries, the location information can be screened against the USPS and other nations mailing address data base to establish and secure the entry validity. This procedure is implemented to avoid any possible wrongdoing, calamities or deceit.

FIG. 2 also shows that the user interface 200 can include a communication module 204. In at least one implementation, the communication module 204 can allow a user to communicate by means of the exchange indirectly with other users or service providers and vice versa. In particular, the communication module 204 can allow a user to express interest in a service, product or property, by means of the exchange, as desired. The communication module 204 assures communication between parties to happen on an anonymous basis until parties and the exchange enter into a binding contractual understanding with each other exclusively and independently. I.e., the communication module 204 can allow parties to remain anonymous until the exchange delivers contact information to each party individually. Additionally or alternatively, the communication module 204 can facilitate specific communications.

For example, the communication module 204 can provide a member listing membership expiration reminder. E.g., a reminder can be sent 7 days before the listing expiration to give the user the option to cancel or continue a membership. I.e., as the user's free trial or subscription is ending, the user can be sent an appropriate reminder. Additionally or alternatively, the communication module 204 can provide a member listing renewal notice. E.g., a reminder can be sent 7 days before a listing expiration giving the user the option to cancel or continue the listing or how to upgrade a listing to a higher page ranking and/or multiple category entries.

Additionally or alternatively, the communication module 204 can allow a user to contact a user or client directly. E.g., the contact can include an email response to a services listing user to express interest in the services offered or respond to the services wanted. Additionally or alternatively, the communication module 204 can allow a user to contact another user or client. E.g., the contact can include an email notice to a wanted product listing user “email recipient” stating that the email sender can offer the wanted matter posted by the email recipient. The email sender's message includes specific listing details for the email recipient to look/search for on the site. When the email sender's offered listing is of any interest, the email recipient can either proceed with the task “Make Offer” or “Buy Item”; however, the email recipient is not obligated to respond to the email sender or do anything in return, when disinterested.

Additionally or alternatively, the communication module 204 can allow a user to make an offer. E.g., the exchange, on user's behalf, can send an email offer to the offered product listing service provider, who in return can opt to reject the email offer with request to consider increasing the offer, counter the email offer with a return higher amount, which when acceptable prompt the exchange to procure and pay for the offered service provider object less the applicable transaction fee and instruct email sender to start the Buy Now process to complete the transaction, or accept the email offer which prompt the exchange to procure and pay for the offered service provider object less the applicable transaction fee and instruct email sender to start the buy item process to complete the transaction. Additionally or alternatively, the communication module 204 can allow a user to buy an item. E.g., the user can complete a product purchase with the exchange which informs the user (buyer) about the transaction obligations before starting the payment process. For example, the information states that the amount paid is deposited until the receipt of buyer's transaction acceptance confirmation email on or before the expiry of the 2-day due diligence period reserved for non-fixed assets, or 5-day due diligence time allocated for fixed assets. Upon payment process completion the user (buyer) receives a payment confirmation email, after which the exchange delivers transaction details to each party individually that include contact information and detailed shipping, tracking, inspection, acceptance, and rejection instructions. In case the latter rejection applies, user's (buyer's) deposited funds are refunded in full or otherwise user authorizes the funds release for transaction payment settlement with the exchange.

Additionally or alternatively, the communication module 204 can allow a user to buy now. E.g., as a result of price negotiations ending in service provider's (seller's) counter offer acceptance, the exchange procures and pays the service provider for the offered object less the applicable transaction fee. On transaction procurement completion the exchange and the user (buyer) enter into sales agreement for the negotiated object. At this point user (buyer) and the exchange start the sale process which informs the user (buyer) about the transaction obligations before starting the payment process. The information states that the amount paid is held on deposit for user until the receipt of user's (buyer's) transaction acceptance confirmation email on or before the expiry of the 2-day due diligence period reserved for non-fixed assets, or 5-day due diligence time allocated for fixed assets. Upon payment process completion user (buyer) receives a payment confirmation email, after which the exchange delivers transaction details to each party individually that include contact information and detailed shipping, tracking, inspection, acceptance, and rejection instructions. In case the latter rejection applies, user's (buyer's) deposited funds are refunded in full or otherwise user authorizes the funds release for transaction payment settlement with the exchange.

Additionally or alternatively, the communication module 204 can allow a user to submit a bid. E.g., the user can tender a bid on an offered auction product listing. Each time this process is started the bidder is shown the amount of the last highest recorded bid. After entry of a higher bid amount, the bidder receives an email confirmation of the tender submitted with date and timestamp. Depending on the bidding volume, only the last 5 highest bid amounts per auction listing are recorded. Each time a higher bid is received the tail bid, i.e., the sixth earlier highest bid, is removed from the auction listing recording and the respective bidder receives an email automatically from the communication module 204 stating that his/her offer is removed from the bidding contest. Additionally or alternatively, the communication module 204 can send a winning bid communication. E.g., the communication module 204 can send a notification on auction expiration date to inform the service provider (seller) that the exchange is committed and ready to procure and pay the winning bid amount offered for the auctioned object less the applicable transaction fee. Additionally or alternatively, the communication module 204 can notify the contest winner to start the purchase process and to inform the respective bidder (user/buyer) about the transaction obligations before starting the payment process. The information states that the amount paid is deposited on user's behalf until the receipt of user's (buyer's) transaction acceptance confirmation email on or before the expiry of the 2-day due diligence period reserved for non-fixed assets, or 5-day due diligence time allocated for fixed assets. Upon payment process completion the user (buyer) receives a payment confirmation email, after which the exchange delivers transaction details to each party individually that include contact information and detailed shipping, tracking, inspection, acceptance, and rejection instructions. In case the latter rejection applies, user's (buyer's) deposited funds are refunded in full or otherwise user authorizes the funds release for transaction payment settlement with the exchange.

Additionally or alternatively, the communication module 204 can allow a user to accept a transaction. E.g., the user can, on or before the formal due diligence period expiration, confirm the transaction acceptance and authorize the release of the deposited transaction amount to the exchange. Additionally or alternatively, the communication module 204 can allow a user to reject a transaction. E.g., the user, on or before the formal due diligence period expiration, can confirm a transaction rejection which results automatically in the deposited transaction amount refund within two (2) business days from the product's return delivery confirmation notice. Additionally or alternatively, the communication module 204 can confirm a user refund. E.g., the communication module 204 can send a communication to the transaction rejecter user (buyer) to return ship the rejected product and to start the “Return Tracking” process.

Additionally or alternatively, the communication module 204 can allow a user to track a shipment. E.g., the service provider (seller) can enter shipping method details, which the exchange uses to monitor the shipment arrival at the destination and to track the actual delivery date to determine the start date of the applicable due diligence term. Additionally or alternatively, the communication module 204 can allow a user to enter return tracking information. E.g., the communication module 204 can request the entry of return shipping details and tracking information per the instructions in the refund confirmation, described above. The data submitted is used to track product return arrival at the original ship from address and to determine the actual return delivery date after which the refund is made within two (2) business days from the product's return delivery confirmation notice.

FIG. 2 further shows that the user interface 200 can include a message board 206. In at least one implementation, the message board 206 can be configured to handle calendar- and category-specific event, venue, or special campaign preannouncements to inform audiences about upcoming registered user specific programs. There is no registration requirement for users or visitors to view message board announcements or use the available online board communication tools to RSVP, calendar the event, remind self by email, text to mobile, or inform friends. Users simply select one of the above-mentioned communication choices to start the desired task which launches a webpage requesting to enter the relevant information and submit the query.

For example, message board preannouncement placements can be made up to twelve (12) months in advance and stay on the board until the announcement expiration date or when withdrawn. Registered users can place as many announcements on the board in as many categories to run their personal or business affairs as effectively as needed. Once an announcement shows on the message board the option exists to add or remove services listings or regular product listings using the ADD ITEM button or the REMOVE ITEM button, respectively. Either option requires two easy steps to execute each task. Added listings need to pertain to the actual registered user event, venue, or campaign announcement. No charge applies to the unlimited inclusion of services or product listings. Auction product listings are excluded from message board placement.

FIG. 2 additionally shows that the user interface 200 can include a deposit payment services system 208. In at least one implementation, the deposit payment services system 208 handles all online payment settlements for sales transactions payments between the exchange and registered users (buyers) which payments are held on deposit for user (buyer) until the buyer is fully satisfied with the transaction outcome. Use of the deposit payment system 208 is mandatory for all online transaction payments between the exchange and the service provider and vice versa, and the exchange and the user (buyer) to protect the buyer against deception or fraud.

To settle a sales transaction between the user and the exchange, users (buyers) must follow the online payment settlement instructions and payment system links to provide the information requested. Unless there are sufficient funds held on deposit for user's (buyer's) behalf, user (buyer) unequivocally accepts and authorizes the exchange to charge user's (buyer's) credit card, debit card or bank account for any and all transactions entered into mutually and willingly. The deposit relationship between the exchange and user (buyer) terminates automatically each time buyer funds held on deposit are released. The deposit service is an integral part of the payment services system and is available for free, and free of charge are all registered user card and bank transaction payments.

FIG. 2 moreover shows that the user interface 200 can include a services category menu 210. In at least one implementation, the services category menu 210 can allow a user to select from desired services to be acquired. Additionally or alternatively, the services category menu 210 can allow a service provider to list services for hire, rent or sale to users. For example, the services category menu 210 can include crafts, occupations, professions, sport and recreation and other services. One of skill in the art will appreciate that the services can lead to subcategories, through multiple levels, if so desired.

FIG. 2 also shows that the user interface 200 can include a products category menu 212. In at least one implementation, the products category menu 212 can allow a user to select from desired products to be rented or purchased. Additionally or alternatively, the products category menu 212 can allow a service provider to list products for rent or sale. For example, the products category menu 212 can include antiques and collectibles, apparel and accessories, college books and publications, computers and technology, consumer electronics, food and wine, home and garden, home entertainment, real estate, sports equipment and protective gear, vehicles (air/road/water) and heavy equipment, extraordinary products and other products. One of skill in the art will appreciate that the products categories can lead to subcategories, through multiple levels, if so desired.

FIG. 2 also shows that the user interface 200 can include a jobs category menu 214. In at least one implementation, the products category menu 214 can allow a user to search for, and select or recruit from desired jobs listed. Additionally or alternatively, the jobs category menu 214 can allow a service provider to list offered or wanted jobs. For example, the jobs category menu 214 can include accounting/finance/insurance, administrative/clerical, banking/real estate/mortgage professionals, biotech/R&D/science, building construction/skilled trades, business/strategic management, creative/design, customer support/client care, editorial/writing, education/training, engineering, food services/hospitality, human resources, installation/maintenance/repair, IT/software development, legal, logistics/transportation, manufacturing/production/operations, marketing/product, medical/health, project/program management, quality assurance/safety, sales/retail/business development, security/protective services, styling/modeling, other jobs. One of skill in the art will appreciate that the jobs categories can lead to subcategories, through multiple levels, if so desired.

FIG. 2 further shows that the user interface 200 can include a main menu 216. In at least one implementation, the main menu 216 can allow a user to select desired options within the user interface 200. For example, the main menu 216 can include: board announcements, which can launch the message board webpage to view current scheduled announcements and enter new announcements; create an account, which launches the webpage for account registration; log in, which launches the webpage to log in and handles invalid logins or forgotten password situations by either allowing a system-generated security code entry or temporary password assignment, the latter send by email to the original account holder's registered email address; my account, which gives the logged in user access to his/her account information and permissions to edit or withdraw a listing, or edit or delete the user account listing; my listings, which provides access to the logged in user's active offered, wanted, and auction listings each with their respective individual list and activity status and can show inbound bids and offers on active listings, as well as the user's outbound bids and offers made on other users' listings and send an response to an offer originator to reject sender's offer while asking to reconsider increasing the offer, counter sender's offer with a higher amount, which when acceptable sender can start the buy now process, or accept sender's offer with instruction to start the buy item process to complete the transaction; request new category, which launches a webpage request for a new category or subcategory addition to the existing category tree; submit new listing, which launches the webpage for either a new services profile listing or product listing entry; about us, which launches a webpage which gives unrestricted access to company info, employment, mission statement, news and payment protection; help; site polices; and location selection.

For example, the help menu can provide contact information. E.g., it can provide users with an option of seeking help for a new category request, member cancellation, member renewal, listing withdrawal, payment question, copyright infringement, email opt out, media inquiry, service complaint, transaction dispute or other information. Additionally or alternatively, the help menu can allow a user to address online access related issues, such as support requests, forgot password, forgot login user id and other issues. Additionally or alternatively, the help menu can provide access to website use questions arranged per main topic, such as registration questions, access questions, navigation questions, transaction questions, payment questions, message board questions, website questions and other questions.

Additionally or alternatively, the site policies can cover payment terms. E.g., the site policies can disclose all terms and conditions relevant to regular and auction transactions. However, regardless the transaction type, all funds paid are held on deposit on user's (buyer's) behalf and are released to the exchange for transaction payment settlement within two (2) business days after the user's (buyer's) email instruction confirmation receipt that the transaction is accepted and final. Additionally or alternatively, the site policies can cover a pricing program. E.g., the site policies can disclose terms and conditions relevant to pricing fees which are divided in member profile listing charges and product rent or sale transaction fees. All member profile listings and for rent or sale product listings are free from insertion fees. Member profile listing entries are free of charge for the first 3 months from registration date. Additionally or alternatively, the site policies can cover privacy policy. E.g., the site policies can describe the full privacy policy on how the privacy and personal information of the site's members, registered users and visitors is treated. Additionally or alternatively, the site policies can cover terms of service. E.g., the site policies can describe the terms of use all users, whether registered or non-registered, should observe and obey when active on the site.

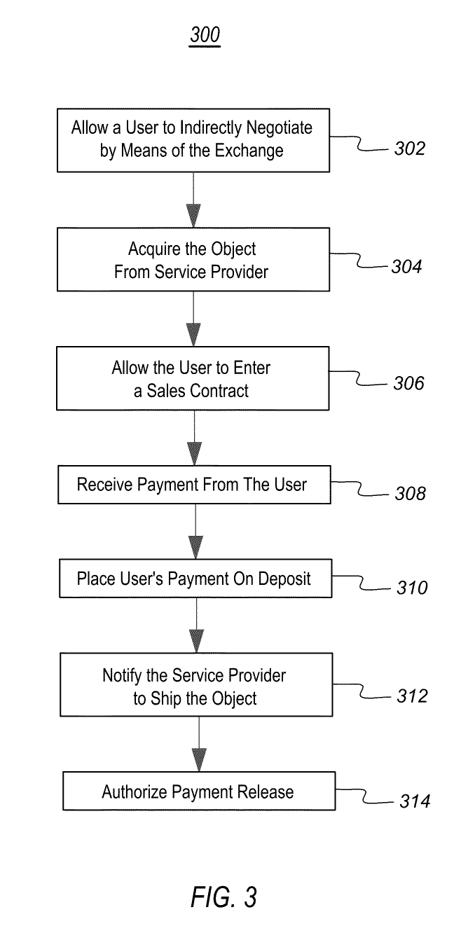

FIG. 3 is a flowchart illustrating a method 300 of completing a transaction. In at least one implementation, the transaction is executed exclusively by means of the exchange on behalf of a user with a service provider. In particular, the exchange mediates, procures and pays the service provider for a transaction offered for rent or sale in advance and for the exchange's own account.

FIG. 3 shows that the method 300 can include allowing 302 a user to indirectly negotiate by means of the exchange exclusively with a service provider. In at least one implementation, allowing 302 a user to negotiate can include the user to determine a service, product or property to acquire for a set or negotiated rent or sale price. For example, allowing 302 a user to negotiate can include a service, product or property or the user requesting the service, product or property. Additionally or alternatively, allowing 302 a user to negotiate can include the user agreeing on a price for the service, product or property.

FIG. 3 also shows that the method 300 can include acquiring 304 the object from the service provider (seller). In at least one implementation, the exchange acquires 304 the object and pays the service provider (seller) the set or negotiated price at the time of procurement. I.e., the exchange acts as merchant ensuring that the object is in its control or possession, before selling the object to anyone interested thereafter.

FIG. 3 further shows that the method 300 can include allowing 306 the user (buyer) to enter a sales contract. In at least one implementation, the sales contract can include the service, product or property to be sold, the time for delivery, the sale price and any other required information. In particular, the exchange can produce a sales contract that assures the user (buyer) of purchase and inspection validation followed by accept or reject confirmation before deposit payment release to the exchange.

FIG. 3 additionally shows that the method 300 can include receiving 308 payment from the user (buyer). In at least one implementation, receiving 308 payment from the user (buyer) can include the exchange placing the payment in a deposit account. In particular, placing the payment in a deposit account can provide the user (buyer) with an assurance that he/she will not lose payment in case of non-performance, non-delivery, non-arrival, damaged condition, misrepresentation, non-disclosure, or pure irresponsible behavior of the service provider resulting in the transaction cancellation or rejection.

FIG. 3 moreover shows that the method 300 can include the exchange placing 310 user's (buyer's) payment on deposit until user (buyer) accepts or rejects the transaction based on any findings discovered during the inspection term. For example, the inspection term can include a 2-day due diligence period reserved for non-fixed assets, or a 5-day due diligence time allocated for fixed assets.

FIG. 3 also shows that the method 300 can include the exchange notifying 312 the service provider to ship the object or give access to the object for inspection. In at least one implementation, the service provider can be sent an email, text message or any other communication. Notifying 312 the service provider (seller) to deliver the service, product or property is the first step in the transaction completion process that assures that the service provider (seller) can or will deliver the object acquired by the exchange.

FIG. 3 further shows that the method 300 can include authorizing 314 payment release to settle payment with the exchange. In at least one implementation, authorizing 314 payment release to the exchange can occur after the user (buyer) confirms that the transaction is complete and final. In particular, waiting to release 314 payment to the exchange provides the user (buyer) with an assurance that he/she will not lose payment when the service, product or property is not delivered or the inspection establishes substantial material discrepancies or omissions inconsistent with the service, product or property listing disclosures or statements. I.e., the deposit account can act as a “buffer” assuring the user (buyer) to be free from any payment loss risk up to the moment of transaction acceptance confirmation.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

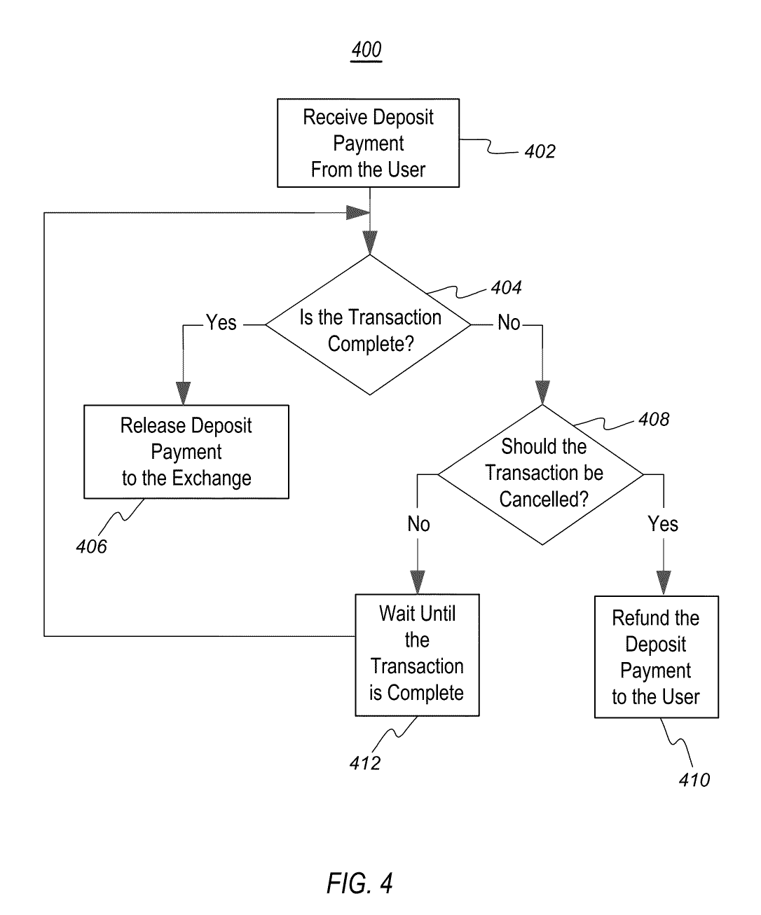

FIG. 4 is a flowchart illustrating a method 400 of depositing a payment. In at least one implementation, the method 400 can allow payment to be held on deposit by the exchange to ensure that the user (buyer) promptly settles payment with the exchange.

FIG. 4 shows that the method 400 can include receiving 402 deposit payment from the user (buyer). In at least one implementation, receiving 402 deposit payment from the user (buyer) can include receiving the funds for the transaction from the user. For example, the user (buyer) may have funds that are already available in an attached account. E.g., the user (buyer) can place funds in an account to be used at a later date, can have a refund that is held for future transactions or is otherwise being held for the user (buyer). Additionally or alternatively, receiving 402 deposit payment from the user (buyer) can include receiving information that can be used to make the payment at the appropriate time. For example, receiving 402 deposit payment from the user (buyer) can include retaining a credit card/debit, bank account number, or other information that will allow the payment to be completed at the completion of the transaction. One of skill in the art will appreciate that the deposited funds may not be an exact amount. For example, the payment may be on an hourly basis or otherwise be undetermined at the beginning of the transaction. Such cases can include a down payment, enough deposited funds to cover payment, or a payment method that can be changed at the time that the transaction is completed.

FIG. 4 also shows that the method 400 can include determining 404 if the transaction is complete. In at least one implementation, determining 404 if the transaction is complete can include monitoring shipping information or other information that is an indication of a completed transaction. Additionally or alternatively, determining 404 if the transaction is complete can include the user (buyer) indicating that the transaction is complete. I.e., the user (buyer) can notify the exchange that the transaction is complete.

FIG. 4 further shows that the method 400 can include releasing 406 deposit payment to the exchange if the transaction is complete. In at least one implementation, releasing 406 deposit payment to the exchange can include settling a transaction payment with the exchange. For example, releasing 406 deposit payment to the exchange can include depositing the payment into an account designated by the exchange. Additionally or alternatively, releasing 406 deposit payment to the exchange can include sending a check or other payment to the service provider.

FIG. 4 additionally shows that the method 400 can include determining 408 if the transaction should be cancelled. In at least one implementation, the transaction can be cancelled by either the user (buyer) or the exchange before beginning. Additionally or alternatively, if the user (buyer) indicates that the service, product or property was not delivered as promised or does not meet the condition(s) as described, then the transaction can be cancelled.

FIG. 4 moreover shows that the method 400 can include refunding 410 the deposit payment to the user (buyer) if the transaction should be cancelled. In at least one implementation, refunding 410 the deposit payment to the user (buyer) can include crediting the funds to the original account user (buyer) used to make the payment. Additionally or alternatively, refunding 410 the deposit payment to the user (buyer) can include preventing a charge based on the payment information. I.e., the user's credit card can be deleted rather than being charged.

FIG. 4 also shows that the method 400 can include waiting 412 until the transaction is complete. In at least one implementation, waiting 412 can include the user (buyer) and/or the exchange indicating that completion of the transaction has been delayed and that the delay is acceptable to both parties. I.e., waiting 412 until the transaction is complete can include confirming that both the user (buyer) and the exchange are aware of the delay and find the delay acceptable.

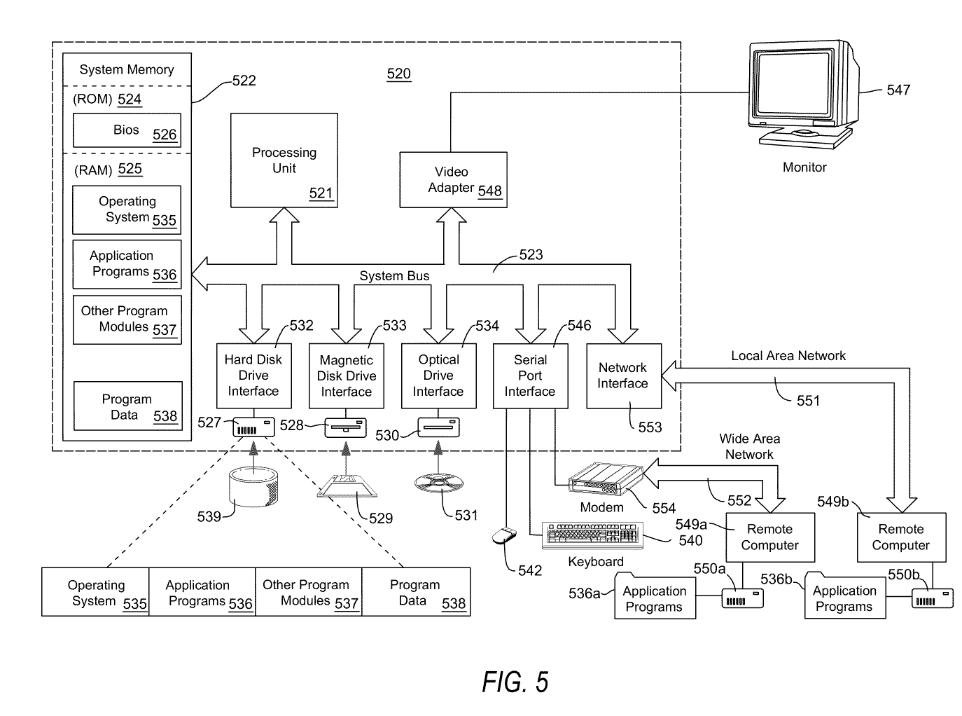

FIG. 5, and the following discussion, are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that performs particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

One of skill in the art will appreciate that the invention may be practiced in network computing environments with many types of computer system configurations, including personal computers, hand-held devices, mobile phones, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 5, an example system for implementing the invention includes a general purpose computing device in the form of a conventional computer 520, including a processing unit 521, a system memory 522, and a system bus 523 that couples various system components including the system memory 522 to the processing unit 521. It should be noted however, that as mobile phones become more sophisticated, mobile phones are beginning to incorporate many of the components illustrated for conventional computer 520. Accordingly, with relatively minor adjustments, mostly with respect to input/output devices, the description of conventional computer 520 applies equally to mobile phones. The system bus 523 may be any of several types of bus structures including a memory bus or memory controller, a peripheral bus, and a local bus using any of a variety of bus architectures. The system memory includes read only memory (ROM) 524 and random access memory (RAM) 525. A basic input/output system (BIOS) 526, containing the basic routines that help transfer information between elements within the computer 520, such as during start-up, may be stored in ROM 524.

The computer 520 may also include a magnetic hard disk drive 527 for reading from and writing to a magnetic hard disk 539, a magnetic disk drive 528 for reading from or writing to a removable magnetic disk 529, and an optical disc drive 530 for reading from or writing to removable optical disc 531 such as a CD-ROM or other optical media. The magnetic hard disk drive 527, magnetic disk drive 528, and optical disc drive 530 are connected to the system bus 523 by a hard disk drive interface 532, a magnetic disk drive-interface 533, and an optical drive interface 534, respectively. The drives and their associated computer-readable media provide nonvolatile storage of computer-executable instructions, data structures, program modules and other data for the computer 520. Although the exemplary environment described herein employs a magnetic hard disk 539, a removable magnetic disk 529 and a removable optical disc 531, other types of computer readable media for storing data can be used, including magnetic cassettes, flash memory cards, digital versatile discs, Bernoulli cartridges, RAMs, ROMs, and the like.

Program code means comprising one or more program modules may be stored on the hard disk 539, magnetic disk 529, optical disc 531, ROM 524 or RAM 525, including an operating system 535, one or more application programs 536, other program modules 537, and program data 538. A user may enter commands and information into the computer 520 through keyboard 540, pointing device 542, or other input devices (not shown), such as a microphone, joy stick, game pad, satellite dish, scanner, motion detectors or the like. These and other input devices are often connected to the processing unit 521 through a serial port interface 546 coupled to system bus 523. Alternatively, the input devices may be connected by other interfaces, such as a parallel port, a game port or a universal serial bus (USB). A monitor 547 or another display device is also connected to system bus 523 via an interface, such as video adapter 548. In addition to the monitor, personal computers typically include other peripheral output devices (not shown), such as speakers and printers.

The computer 520 may operate in a networked environment using logical connections to one or more remote computers, such as remote computers 549a and 549b. Remote computers 549a and 549b may each be another personal computer, a server, a router, a network PC, a peer device or other common network node, and typically include many or all of the elements described above relative to the computer 520, although only memory storage devices 550a and 550b and their associated application programs 536a and 536b have been illustrated in FIG. 5. The logical connections depicted in FIG. 5 include a local area network (LAN) 551 and a wide area network (WAN) 552 that are presented here by way of example and not limitation. Such networking environments are commonplace in office-wide or enterprise-wide computer networks, intranets and the Internet.

When used in a LAN networking environment, the computer 520 can be connected to the local network 551 through a network interface or adapter 553. When used in a WAN networking environment, the computer 520 may include a modem 554, a wireless link, or other means for establishing communications over the wide area network 552, such as the Internet. The modem 554, which may be internal or external, is connected to the system bus 523 via the serial port interface 546. In a networked environment, program modules depicted relative to the computer 520, or portions thereof, may be stored in the remote memory storage device. It will be appreciated that the network connections shown are exemplary and other means of establishing communications over wide area network 552 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system embodied on a computer-readable storage medium bearing computer-executable instructions that, when executed by a processor operatively coupled to memory on a computer that includes a client application for allowing a user and service provider to complete an online transaction, the system comprising:
a processor; and
one or more computer readable media, wherein the one or more computer readable media contain a set of computer-executable instructions, the set of computer-executable instructions configured to:
connect a user over a network to:
an exchange; and
a service provider through the exchange;
allow the user to negotiate a transaction by means of the exchange with the service provider;
allow the exchange and user to enter into a sales contract;
receive a payment from the user for deposit hold until completion of the transaction; and
release the user deposit payment to the exchange.

2. The system of claim 1, wherein connecting the user over the network to the exchange and to the service provider includes the user requesting the transaction.

3. The system of claim 2, wherein connecting the user over the network to the exchange and to the service provider includes the service provider responding to an exchange request on behalf of the user.

4. The system of claim 1, wherein connecting the user over the network to the exchange and to the service provider includes the exchange requesting the transaction from the service provider.

5. The system of claim 1, wherein connecting the user over the network to the exchange and to the service provider includes the exchange indicating the service provider has a service for sale.

6. The system of claim 1, wherein connecting the user over the network to the exchange and to the service provider includes the exchange indicating the service provider has a product for sale.

7. The system of claim 1, wherein connecting the user over the network to the exchange and to the service provider includes the exchange indicating the service provider has a property for sale.

8. The system of claim 1, wherein allowing the user by means of the exchange to indirectly negotiate a transaction with the service provider includes the user offering a price.

9. The system of claim 1, wherein allowing the user by means of the exchange to indirectly negotiate a transaction with the service provider includes the service provider offering a price.

10. The system of claim 1, wherein allowing the user by means of the exchange to indirectly negotiate a transaction with the service provider includes the exchange and the service provider agreeing on a price.

11. A system embodied on a computer-readable storage medium bearing computer-executable instructions that, when executed by a processor operatively coupled to memory on a computer that includes a client application for allowing a user and service provider to complete an online transaction, the system comprising:
a processor; and
one or more computer readable media, wherein the one or more computer readable media contain a set of computer-executable instructions, the set of computer-executable instructions configured to:
connect a user over a network to:
an exchange; and
a service provider through the exchange;
allow the user to negotiate a transaction by means of the exchange with the service provider, wherein the transaction includes:
at least one of:
a service
a product; or
property;
to be procured and paid for by the exchange for own account and in advance; and
allow the exchange and the user to enter into a sales contract;
receive a payment from the user;
hold the payment from the user on deposit until the transaction is complete; and
release the payment to the exchange on transaction completion.

12. The system of claim 11, wherein receiving the payment from the user includes receiving funds from the user.

13. The system of claim 11, wherein receiving the payment from the user includes receiving payment information from the user.

14. The system of claim 13, wherein the payment information includes at least one of:
a credit card number;
a debit card number; or
a bank account number.

15. The system of claim 11, wherein releasing the payment to the exchange includes depositing the payment in a deposit account designated by the exchange to protect the exchange against user's lawful payment revocation.

16. A system embodied on a computer-readable storage medium bearing computer-executable instructions that, when executed by a processor operatively coupled to memory on a computer that includes a client application for allowing a user and service provider to complete an online transaction, the system comprising:
a processor; and
one or more computer readable media, wherein the one or more computer readable media contain a set of computer-executable instructions, the set of computer-executable instructions configured to:
connect a user over a network to:
an exchange; and
a service provider through the exchange;
allow the user to negotiate a transaction by means of the exchange with the service provider, wherein the transaction includes:
at least one of:
a service
a product; or
property;
to be procured and paid for by the exchange for own account and in advance;
allow the exchange and the user to enter into a sales contract;
receive a payment from the user;
hold the payment from the user on deposit until the transaction is complete;
determine if the transaction is complete; and
release the payment to the exchange on transaction completion.

17. The system of claim 16, wherein determining if the transaction is complete includes monitoring shipping information.

18. The system of claim 16, wherein determining if the transaction is complete includes receiving acceptance confirmation from the user.

19. The system of claim 16, wherein determining if the transaction is complete includes receiving shipment tracking confirmation from the service provider.
